(19) United States
(12) Patent Application Publication
(10) Pub. No.: US 2011/0273887 A1
(43) Pub. Date: Nov. 10, 2011

(54) LIGHT FOR OUTDOOR GRILL

(76) Inventor: Raymond Nilssen, II, Greenwood, MS (US)

(21) Appl. No.: 13/100,661

(22) Filed: May 4, 2011

Related U.S. Application Data
(60) Provisional application No. 61/331,073, filed on May 4, 2010.

(51) Int. Cl. F21V 14/02

(52) U.S. Cl. 362/277

(57) ABSTRACT

A lighting assembly for an outdoor grill or similar type of cooking assembly includes a base having a first end mountable within a receptacle located along a surface of the grill. An illumination source is located at a second end of the base. A directional cap is applied over the illumination source and redirects the light provided by the illumination source toward a desired area or areas of a cooking surface or preparation area of the grill.

### CROSS REFERENCE TO RELATED APPLICATION

The present patent application is a formalization of previously filed, co-pending U.S. Provisional Patent Application Ser. No. 61/331,073, filed May 4, 2010 by the inventor named in the present Application. This patent application claims the benefit of the filing date of this cited Provisional patent application according to the statutes and rules governing provisional patent applications, particularly 35 U.S.C. §119(a)(i) and 37 C.F.R. §1.78(a)(4) and (a)(5). The specification and drawings of the Provisional patent application referenced above are specifically incorporated herein by reference as is set forth in their entirety.

### FIELD OF THE INVENTION

The present disclosure generally relates to a lighting assembly for an outdoor grill. More specifically, the present disclosure relates to a lighting assembly that is removably attached to an outdoor grill and that can be oriented and/or positioned to illuminate a cooking surface or a preparation surface of the grill.

### BACKGROUND OF THE INVENTION

Grilling or cooking outdoors has become increasingly popular with consumers. As a result, cooking out has become more of a year-round activity for many consumers, as opposed to being primarily a summertime activity. With this increased popularity of grilling or cooking out, outdoor grills have now become much more sophisticated, offering customers more and more amenities and optional convenience features. For example, many gas grills now have side shelves, some including side burners in addition to the grilling surface, and some grills even include integrally mounted lights generally mounted within the hood of the grill so as to illuminate the grilling surface. However, such lights typically are limited in size and the amount of illumination they can provide, and additionally generally require an outside source of power to be connected to the grill. Still further, such lights often can become clouded or fouled by smoke, grease, etc., resulting from the cooking process, which further hampers the use of such lights and renders them ineffective.

Accordingly, it can be seen that a need exists for a lighting assembly for outdoor grills that addresses the foregoing and other related and unrelated problems in the art.

### SUMMARY OF THE INVENTION

Briefly described, the present invention generally relates to a lighting assembly for use with cooking assemblies such as outdoor grills and the like. The present lighting assembly also can be used on other cabinetry and is not limited only to use with grills.

In one example embodiment, the lighting assembly generally will include an assembly base having a first end and a second end and defining a substantially tubular body therebetween. An illumination source generally is provided at a first end of the base for providing a source of light to a desired area of the grill. The base can comprise a lamp, flashlight with a light bulb, LED or other type of lighting mechanism as the illumination source thereof. A directional cap further generally is releasably mounted over the first end of the base, and thus over the illumination source, so as to substantially cover the illumination source. The directional cap can include one or more reflective surfaces for redirecting the light from the illumination source and a lens for focusing the light toward or over desired areas. The cap further typically can be rotatable and/or pivotable with respect to the first end of the base so as to enable redirection and/or focusing of the light provided by the light source toward desired areas of the cooking surface of the grill or preparation surfaces, or both, as needed or desired.

Typically, a receptacle will be formed in the grill adjacent both the cooking surface and one or more preparation surfaces of the grill. The receptacle can include a recess, opening, mounting hole or other mechanism adapted to receive the second end of the base therein in mating engagement with the second end. A stop can be provided at the bottom of the receptacle and/or a clamp mechanism or similar releasable fastener also can be provided adjacent the lower end of the receptacle for engaging the second end of the base when the base has been received within the receptacle. As a result, the second end of the base generally will be secured to the grill in a stable and secure position while still enabling adjustment of the base as needed to further adjust the direction of the light being provided by the illumination source for illuminating the desired areas of the cooking surface and/or preparation surface(s) of the grill.

Those skilled in the art will appreciate the above stated advantages and other objects, features, advantages and benefits of various additional embodiments upon reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 shows a perspective view of an outdoor grill with a lighting assembly according to the principles of the present invention.

FIG. 2 shows an exploded view of the lighting assembly and grill of FIG. 1.

FIG. 3 shows the lighting assembly of FIGS. 1-2 received in a seated position in a mounting hole with the light turned on.

FIG. 4 shows another embodiment of the lighting assembly with the light turned on.

Corresponding parts are designated by corresponding reference numbers throughout the drawings.

### DETAILED DESCRIPTION

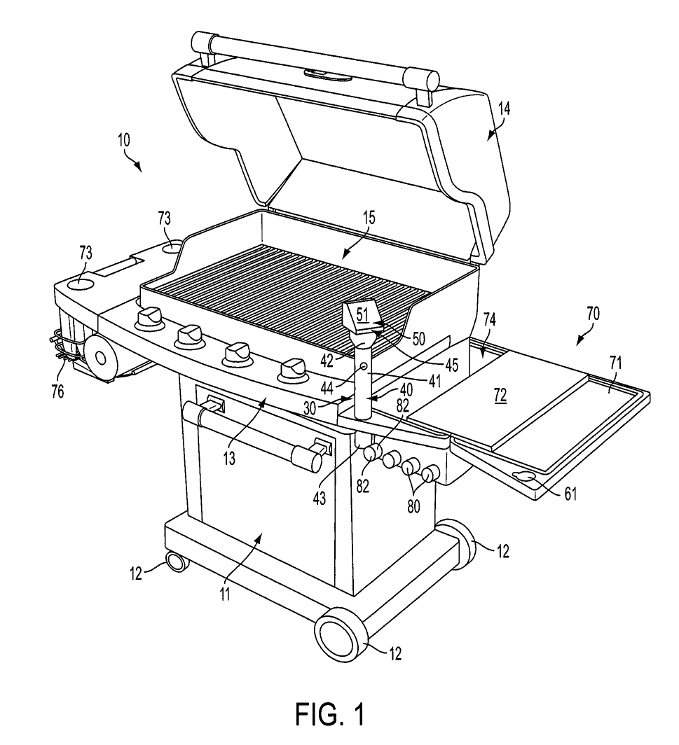

Referring now to the drawings in which the numerals indicate like parts throughout the several views, FIGS. 1-4 show views of one embodiment of an outdoor grill 10 incorporating a lighting assembly 30 according to the principles of the present invention. In the illustrated embodiments of the present invention, the lighting assembly 30 is shown as being mountable to an outdoor grill 10, such as a gas, charcoal or electric grill. However, it will be understood by those skilled in the art that the lighting assembly also can be used with other types of cooking assemblies including mobile and fixed, stationary cooking assemblies. As shown in FIG. 1, the grill 10 generally includes a base 11 (which can be mounted on rollers 12) and an upper portion 13 including a firebox 14 having a grill surface 15 defining a grilling or cooking area and being coverable by a lid 5. The grill surface can be further divided into one or more cooking zones or areas that can be independently heated as needed.

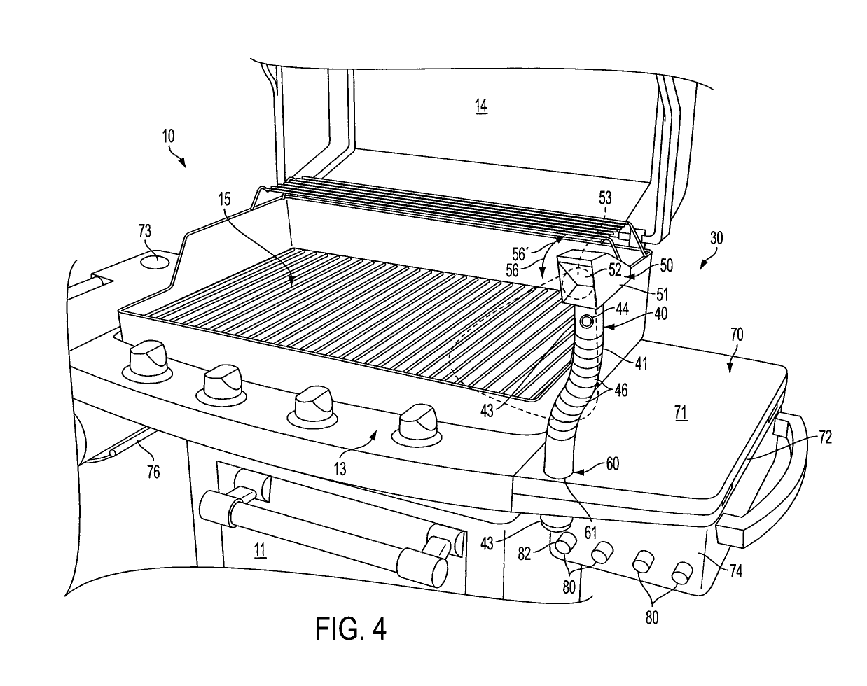

As shown in FIGS. 1-3, the lighting assembly 30 generally includes an assembly base 40 and a directional cap 50. The base 40 can comprise a flashlight or lamp, and can include an elongated, generally tubular body 41 sized to receive a battery or batteries (not shown) and extending between an upper or first end 42 and a second or lower end 43, and can include a light bulb, LED, or other illumination source (indicated at 45). Additionally, as shown in FIG. 4, the body portion 41 of the base 40 can include an actuating switch 44 from turning the illumination source on and off, and further can be formed with a series of extensible or articulatable sections 46 or can be otherwise formed with a flexible construction so as to enable its positioning or alignment into a variety of desired orientations as needed for lighting the grill surface or portions thereof.

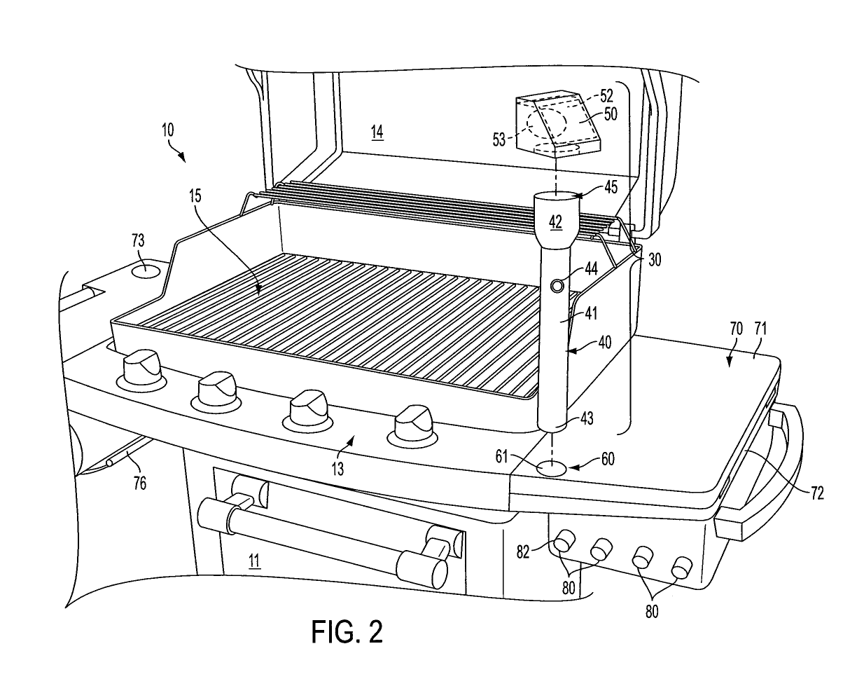

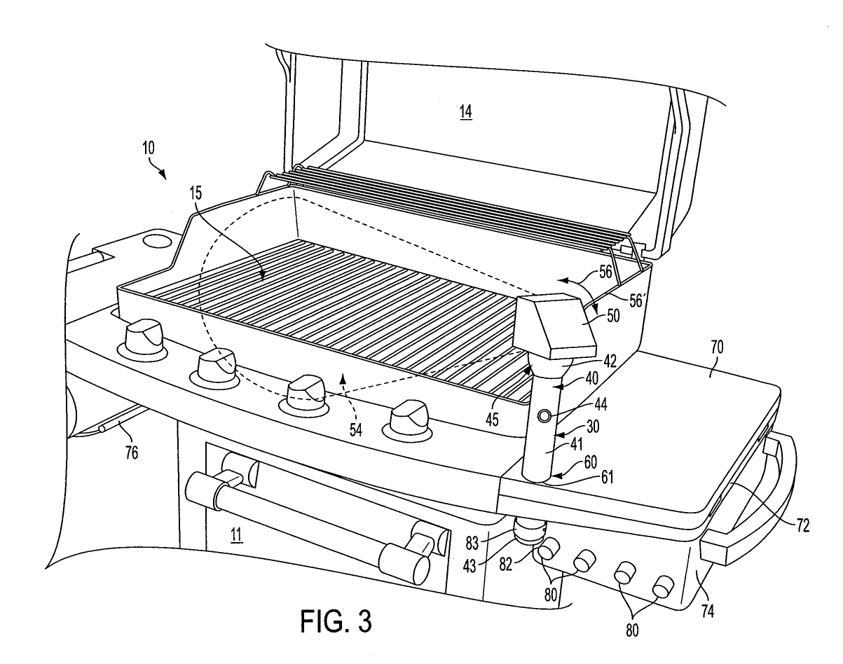

As indicated in FIGS. 2-3, the cap 50 is mountable on the upper end 42 of the assembly base 40 and can be rotated or turned as needed for directing light to a desired area. The cap is shown as having a housing 51 that generally is formed with a triangular, rectangular, oval, square, or other, similar design or configuration. The cap also can include one or more directional mirrors or other reflecting surfaces (shown in phantom lines 52 in FIG. 2) that redirect the light emitted from the illumination source 45 of the base 40 at, for example, between an approximately 30-90-degree angle, although other illumination angles also can be used. The directional mirror(s) 52 of the cap and/or the cap itself also can be adjustable, and an adjustable lens 53 can be fitted over a front portion of the cap to enable adjustment or focusing of the light from the illumination source, including the direction, intensity and expansion or reduction of the area of coverage provided thereby.

As FIG. 1 illustrates, the grill 10 further can include grill tool hang protrusions 80, which are capable of holding grilling utensils or other tools for ease of use during grilling, a foldable shelf or preparation 70 that can be folded out to provide an exploded preparation area 71, a removable cutting board 72 and/or other accessories such as cup-holders 73, storage containers 74, baskets 76, etc. The grill 10 further is shown in FIGS. 1-4 with a preparation surface 70, which is shown adjacent a mounting hole or receptacle 60 for the lighting assembly 30.

Mounting hole 60 is capable of receiving and securely supporting the lighting assembly 30 in an illuminating position along the grill, and allowing the lighting assembly 30 to be easily rotated or oriented therein as needed, or even removed therefrom to allow, for example, a user to direct the light more specifically in a certain area. As indicated in FIG. 1, the mounting hole 60 generally is formed in both portions of the foldable shelf 70, with the upper portion 61 of the mounting hole 60 possibly further acting as a cup-holder for the extended portion 71 of shelf 70. One of the grill tool hang protrusion 80 closest to the grill surface 15 and mounting hold 60 (i.e., the protrusion identified by numeral 82 in FIG. 1) can be located so as to interact with the lighting assembly 30 when received in the mounting hole 60 to provide a stop and/or lower support for the lighting assembly 30 enabling it to be received in a stable and securely supported arrangement in the mounting hole 60 in a friction-fitting arrangement. Since the base 40 of the lighting assembly 30 generally is cylindrical, the lighting assembly 30 further typically can be rotated 360 degrees. Also, with the flexible or articulated body 46 of the lighting assembly base 40 shown in FIG. 4, the lighting assembly further can be oriented, turned or otherwise placed in a variety of differing illuminating alignments.

FIG. 2 shows the lighting assembly 30 of FIG. 1 being assembled as a unit. As shown in FIG. 2, the cap 50 can be affixed or adjustably attached to the base 40 to form lighting assembly 30. Generally, the cap 50 can be snapped, be threaded onto, or otherwise attached to the base 40 to secure the cap 50 to the first or upper end 42 thereof. As indicated by dashed lines 54 in FIG. 3, the cap 50 also can be rotatable with respect to the base 40 to enable direction of the light/illumination and focusing of the illumination at or about a desired area of the grill/cooking surface 15 as indicated by arrows 56 and 56′. Additionally, the cap could be designed with focusable lens 53 so as to focus or to spread or diffuse the light provided by the illumination source 45 over a smaller or wider area/amount of the preparation surface 70 and/or cooking surface of the grill surface 15.

FIG. 3 shows the lighting assembly 30 of FIG. 2 being received in a position seated in the mounting hole 60, with the lighting assembly 30 shown here as contacting and resting on a grill tool hang protrusion 82. Other supports or holders, such as a clamp or similar locking device 83 also can be used to secure the lighting assembly base to the grill and fix it in a desired orientation/position with respect to the grill surface.

FIGS. 3-4 also show the lighting assembly 30 of FIG. 4 with the light turned on. As shown, the light emitting from the illumination source 45 of the base 40 is redirected by cap 50 onto the cooking area of the grill surface 15. Alternatively, as shown in FIG. 4, the lighting assembly 30 also can be rotated when received in the mounting hole 60 to illuminate other areas of the grill surface or surrounding the grill, for example, being rotated to a position to at least illuminate the preparation surface 70, and/or to provide light to both the grill surface and preparation surface 70.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments that are within the scope of the claims.

Additionally, while the disclosure shows and describes selected embodiments of the disclosure, the disclosure is capable of use in various other combinations, modifications, and environments and is capable of changes or modifications within the scope of the inventive concept as expressed herein, commensurate with the above teachings, and/or within the skill or knowledge of the relevant art. Furthermore, various features and characteristics of the disclosed embodiments may be selectively interchanged and applied to other illustrated and non-illustrated embodiments of the disclosure.

What is claimed is:

1. A lighting assembly for an outdoor grill, comprising:
an assembly base having a body with a first end and a second end;
an illumination source at said first end of said assembly base for providing light to desired areas of the grill;
a directional cap releasably mounted on said first end of said assembly base so as to substantially cover said illumination source and adapted to enable redirection and focusing of the light emitted from said illumination source toward the desired areas of the grill; and
a receptacle formed in the grill and adapted to receive and support said second end of said assembly base in engagement therewith;
wherein said assembly base is stably and rotatably supported within said receptacle so as to be secured to the grill while further enabling adjustment of said assembly base as needed to adjust direction of the light provided by said illumination source for illuminating the desired areas of the grill.

2. The lighting assembly of claim 1 and wherein said directional cap comprises a housing adapted to engage and seat upon said first end of said assembly base, and at least one reflection mounted within said housing in a position adapted to redirect the light from said illumination source.

3. The lighting assembly of claim 1 and wherein said receptacle further comprises a clamp for engaging aid securing said second end of said assembly base therein.

4. The lighting assembly of claim 1 and wherein said illumination source comprises a flash light.

5. The lighting assembly of claim 1 and wherein said body of said assembly base comprises a series of articulatable segments.

6. The lighting assembly of claim 1 and further comprising a lens mounted to said directional cap, said lens being adjustable to focus or expand coverage of the light provided by said illumination source.
